(19) United States
(12) Patent Application Publication
(10) Pub. No.: US 2011/0143181 A1
(43) Pub. Date: Jun. 16, 2011

(54) SEPARATOR, METHOD OF MANUFACTURING SEPARATOR, AND LITHIUM SECONDARY BATTERY INCLUDING SEPARATOR

(75) Inventor: Changbum Ahn, Suwon-si (KR)

(73) Assignee: SAMSUNG SDI CO., LTD., Yongin-si (KR)

(21) Appl. No.: 12/954,995

(22) Filed: Nov. 29, 2010

(30) Foreign Application Priority Data
Dec. 15, 2009 (KR) 10-2009-0124633

(51) Int. Cl. H01M 2/16; H01M 2/14; B29C 47/00

(52) U.S. Cl. 429/144; 156/244.11

(57) ABSTRACT

A lithium secondary battery includes a positive electrode plate, a negative electrode plate, and a separator disposed between the positive electrode plate and the negative electrode plate. The separator includes a first porous base material layer, a second porous base material layer and a ceramic layer disposed between the first base material layer and the second base material layer. Since the lithium secondary battery includes the separator having the interposed ceramic layer, the melting and contraction of the separator due to heat are inhibited, thus preventing a short circuit between the positive electrode plate and the negative electrode plate.

### CROSS-REFERENCE TO RELATED APPLICATIONS

This application makes reference to, incorporates the same herein, and claims all benefits accruing under 35 U.S.C. §119 from an application earlier filed in the Korean Intellectual Property Office on Dec. 15, 2009 and there duly assigned Serial No. 2009-0124633.

### BACKGROUND

1. Field

Embodiments relate to a separator, a method of manufacturing the separator, and a lithium secondary battery including the separator.

2. Description of the Related Art

In general, a lithium secondary battery includes a positive electrode plate, a negative electrode plate, and a separator disposed between the positive electrode plate and the negative electrode plate.

The separator electrically insulates the positive electrode plate and the negative electrode plate from each other, and has minute pores through which lithium ions pass. When the temperature of the battery is over a predetermined temperature, the separator performs a shut down operation to prevent overheat of the battery.

However, even when the pores of the separator are closed by the shut down operation, the separator may be melted down or contracted by already generated heat. When the separator is melted down and contracted, a short circuit may occur between the positive electrode plate and the negative electrode plate.

The above information disclosed in this Background section is only for enhancement of understanding of the background of the described technology and therefore it may contain information that does not form the prior art that is already known in this country to a person of ordinary skill in the art.

### SUMMARY

An aspect of the present invention is a separator, a method of manufacturing the separator, and a lithium secondary battery including the separator, which can inhibit the melting and contraction of the separator due to heat, thus preventing a short circuit between a positive electrode plate and a negative electrode plate.

According to one or more embodiment of the present invention, there is provided a separator for a lithium secondary battery, the separator including a first porous base material layer; a second porous base material layer; and a ceramic layer disposed between the first porous base material layer and the second porous base material layer.

According to one or more embodiment of the present invention, there is provided a lithium secondary battery including: a positive electrode plate, a negative electrode plate, and a separator disposed between the positive electrode plate and the negative electrode plate, wherein the separator includes: a first porous base material layer; a second porous base material layer; and a ceramic layer disposed between the first base material layer and the second base material layer.

The first base material layer and the second base material layer may have a permeability ranging from about 100 sec/100 ml to about 300 sec/100 ml.

At least one of the first and second base material layers may have a porosity ranging from about 30% to about 70% of an entire volume.

At least one of the first and second base material layers may be formed of a polyolefin based resin. The polyolefin based resin may include at least one selected from the group consisting of polyethylene and polypropylene. The first and second base material layers may be formed of a polyolefin based resin, the first base material layer may include at least one selected from the group consisting of polyethylene and polypropylene, and the second base material layer may be formed of polyethylene.

The ceramic layer may include ceramic filler and a binder.

The ceramic filler may include at least one selected from the group consisting of Al₂O₃, TiO₂, and BaTiO₃. The ceramic filler may have a mean particle diameter ranging from about 10 nm to about 1 μm.

The binder may include at least one selected from the group consisting of polyvinylidenefluoride (PVDF) and hexafluoropropane (HFP).

The ceramic layer may have a thickness ranging from about 2 μm to about 5 μm.

The separator may have a thickness ranging from about 15 μm to about 30 μm.

According to another embodiment of the present invention, there is provided a method of manufacturing a separator for a lithium secondary battery, the method including: extruding a melted polyolefin based resin to form a first base material layer and a second base material layer; interposing a ceramic layer between the extruded first and second base material layers; and combining the first base material layer, the second base material layer, and the ceramic layer disposed between the first and second base material layers.

The interposing of the ceramic layer may include coating an inner surface of at least one of the first and second base material layers with a ceramic composition.

The interposing of the ceramic layer may include forming a ceramic composition through electrospinning on an inner surface of at least one of the first and second base material layers.

According to another embodiment of the present invention, there is provided a separator for a lithium secondary battery, the separator being manufactured using the method.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a cross-sectional view illustrating an electrode assembly of a lithium secondary battery according to an embodiment; and

FIG. 2 is a flowchart illustrating a process of manufacturing a separator applied to a lithium secondary battery according to an embodiment.

### DETAILED DESCRIPTION

Exemplary embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Hereinafter, embodiments will be described in detail with reference to the accompanying drawings.

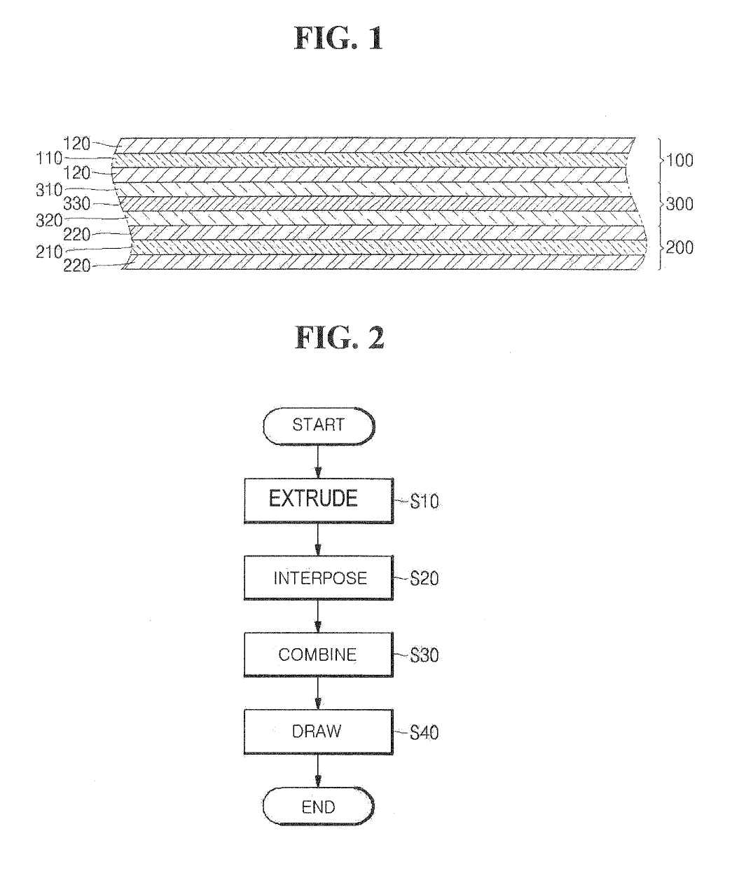

FIG. 1 is a cross-sectional view illustrating an electrode assembly of a lithium secondary battery according to an embodiment.

Referring to FIG. 1, the lithium secondary battery includes a positive electrode plate 100, a negative electrode plate 200, and a separator 300 disposed between the positive electrode plate 100 and the negative electrode plate 200.

The positive electrode plate 100 may include a positive electrode collector 110 and a positive electrode coating 120 provided to one or two sides of the positive electrode collector 110.

The positive electrode collector 110 may have a thickness ranging from about 3 μm to about 500 μm. The positive electrode collector 110 may be formed of any highly conductive material. The positive electrode collector 110 may be formed of stainless steel, aluminum, nickel, titanium, or aluminum or stainless steel surface-treated with one of nickel, titanium, and silver. The positive electrode collector 110 may have a surface with minute convexes and concaves to improve bonding force to the positive electrode coating 120, and be formed of one of various materials such as a film, a sheet, a foil, a net, a porous body, a foamy body, and a nonwoven fabric body.

The positive electrode coating 120 may be formed of positive electrode active material. For example, the positive electrode coating 120 may be formed by coating one or two surfaces of the positive electrode collector 110 with positive electrode active materials. The positive electrode active material may include a layered compound such as a lithium cobalt oxide (LiCoO₂) and a lithium nickel oxide (LiNiO₂), or a compound replaced with one or more transition metals; a lithium manganese oxide such as a chemical formula Li₁₊ₓMn₂₋ₓO₄ (where x ranges from 0 to 0.33), LiMnO₃, LiMn₂O₃, and LiMnO₂; a lithium copper oxide (Li₂CuO₂); a vanadium oxide such as LiV₃O₈, LiFe₃O₄, V₂O₅, and Cu₂V₂O₇; a lithium nickel complex oxide expressed by a chemical formula LiNi₁₋ₓMₓO₂ (where M=Co, Mn, Al, Cu, Fe, Mg, B, or Ga, and x ranges from 0.01 to 0.3); a lithium manganese complex oxide expressed by a chemical formula LiMn₂₋ₓMₓO₂ (where M=Co, Ni, Fe, Cr, Zn, or Ta, and x ranges from 0.01 to 0.1) or Li₂Mn₃MO₈ (where M=Fe, Co, Ni, Cu, or Zn); LiMn₂O₄ with a part of Li elements being replaced with alkaline earth metal ions; a disulfide compound; or Fe₂(MoO₄)₃.

The negative electrode plate 200 may include a negative electrode collector 210 and a negative electrode coating 220 provided to one or two sides of the negative electrode collector 210.

The negative electrode collector 210 may have a thickness ranging from about 3 μm to about 500 μm. The negative electrode collector 210 may be formed of any highly conductive material. The negative electrode collector 210 may be formed of copper, stainless steel, aluminum, nickel, titanium, copper or stainless steel surface-treated with one of nickel, titanium, and silver, or aluminum-cadmium alloy. The negative electrode collector 210, like the positive electrode collector 110, may have a surface with minute convexes and concaves to improve bonding force to the negative electrode coating 220, and be formed of one of various materials such as a film, a sheet, a foil, a net, a porous body, a foamy body, and a nonwoven fabric body.

The negative electrode coating 220 may be formed of negative electrode active material. For example, the negative electrode coating 220 may be formed by coating one or two surfaces of the negative electrode collector 210 with negative electrode active materials. The negative electrode active material may include a carbon such as hard carbon and graphite-based carbon; a metal complex oxide such as LiₓFe₂O₃(0≦x≦1), LiₓWO₂(0≦x≦1), and SnₓMe₁₋ₓMe′_{y}O_{z}(Me: Mn, Fe, Pb, and Ge; Me′: Al, B, P, Si, the elements in the groups I, II and III of the periodic table, and halogen; 0≦x≦1; 1≦y≦3; and 1≦z≦8); a lithium metal; a lithium alloy; a silicon based alloy; a stannum based alloy; a metal oxide such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; a conductive high polymer such as polyacetylene; or a Li—Co—Ni based material.

The separator 300 includes a first base material layer 310, a second base material layer 320, and a ceramic layer 330 disposed between the first and second base material layers 310 and 320.

The separator 300 is disposed between the positive electrode plate 100 and the negative electrode plate 200 and electrically insulates the positive electrode plate 100 and the negative electrode plate 200 from each other. The separator 300 has minute pores through which lithium ions can pass.

The separator 300 may have a thickness ranging from about 15 μm to about 30 μm. When the thickness of the separator 300 is less than about 15 μm, its insulating performance is degraded, and the occurrence frequency of an inner short circuit may be increased. When the thickness of the separator 300 is greater than about 30 μm, the volume of an electrode assembly is increased.

The first base material layer 310 may be formed of a polyolefin based resin.

The polyolefin based resin may include at least one selected from the group consisting of polyethylene and polypropylene, but the present disclosure is not limited thereto.

The first base material layer 310 has minute pores through which lithium ions can pass. The first base material layer 310 may be a shutdown layer. The first base material layer 310 prevents overheat of the battery through shutdown when the temperature of the battery is over a predetermined temperature.

The first base material layer 310 may have a permeability ranging from about 100 sec/100 ml to about 300 sec/100 ml. When the permeability of the first base material layer 310 is less than about 100 sec/100 ml, the large sizes of the pores inhibit the shut down, so that the first base material layer 310 may be melted and contracted by generated heat, and a short circuit may occur between the positive electrode plate 100 and the negative electrode plate 200. When the permeability of the first base material layer 310 is greater than about 300 sec/100 ml, the migration of lithium ions may be inhibited to degrade charge/discharge efficiency.

The first base material layer 310 may have a porosity ranging from about 30% to about 70% of the total volume of the first base material layer 310. When the porosity of the first base material layer 310 is less than about 30%, the migration of lithium ions may be inhibited to degrade charge/discharge efficiency. When the porosity of the first base material layer 310 is greater than about 70%, the large sizes of the pores inhibit the shut down, so that the first base material layer 310 is melted and contracted by generated heat, and a short circuit may occur between the positive electrode plate 100 and the negative electrode plate 200. The porosity of a first base material layer is defined as a ratio of the entire volumes of pores in a first base material layer to the entire volume of the first base material layer.

The second base material layer 320 may be formed of a polyolefin based resin.

The polyolefin based resin may include at least one selected from the group consisting of polyethylene and polypropylene, but the present disclosure is not limited thereto.

The second base material layer 320 has minute pores through which lithium ions can pass. The second base material layer 320 may be a shutdown layer. The second base material layer 320 prevents overheat of the battery through shutdown when the temperature of the battery is over a predetermined temperature.

The second base material layer 320 may have a permeability ranging from about 100 sec/100 ml to about 300 sec/100 ml. When the permeability of the second base material layer 320 is less than about 100 sec/100 ml, the large sizes of the pores inhibit the shut down, so that the second base material layer 320 is melted and contracted by generated heat and a short circuit may occur between the positive electrode plate 100 and the negative electrode plate 200. When the permeability of the second base material layer 320 is greater than about 300 sec/100 ml, the migration of lithium ions may be inhibited to degrade charge/discharge efficiency.

The second base material layer 320 may have a porosity ranging from about 30% to about 70% of the entire volume. When the porosity of the second base material layer 320 is less than about 30%, the migration of lithium ions may be inhibited to degrade charge/discharge efficiency. When the porosity of the second base material layer 320 is greater than about 70%, the large sizes of the pores inhibit the shut down, so that the second base material layer 320 is melted and contracted by generated heat and a short circuit may occur between the positive electrode plate 100 and the negative electrode plate 200. The porosity of a second base material is defined as a ratio of the entire volumes of pores in a second base material layer to the entire volume of the second base material layer.

According to an embodiment, the first base material layer 310 may include at least one selected from the group consisting of polyethylene and polypropylene, and the second base material layer 320 may formed of polypropylene. Alternatively, the first base material layer 310 may be formed of polypropylene, and the second base material layer 320 may include at least one selected from the group consisting of polyethylene and polypropylene. According to an embodiment, the first base material layer 310 may be formed of polypropylene, and the second base material layer 320 may be formed of polyethylene. According to another embodiment, the first base material layer 310 may be formed of polyethylene, and the second base material layer 320 may be formed of polypropylene. The first base material and the second base material may be formed of the same material or different materials.

The ceramic layer 330 is disposed between the first and second base material layers 310 and 320.

In this case, the ceramic layer 330 inhibits melting and contraction of the separator 300 to prevent a short circuit between the positive electrode plate 100 and the negative electrode to plate 200.

The ceramic layer 330 may have a thickness ranging from about 2 μm to about 5 μm. When the thickness of the ceramic layer 330 is less than about 2 μm, it is difficult for the ceramic layer 330 to have a uniform thickness, and difficult to sufficiently prevent melting and contraction of a separator, so that a short circuit may occur more frequently between the positive electrode plate 100 and the negative electrode plate 200. In this case, the strength of the ceramic layer 330 for preventing the first and second base material layers 310 and 320 from being contracted at high temperature may be decreased, so that the stability of the battery may be reduced. When the thickness of the ceramic layer 330 is greater than about 5 μm, the volume of an electrode assembly is increased, so that the energy density of a battery may be reduced.

The ceramic layer 330 may include ceramic filler and a binder. The ceramic filler may have a mean particle diameter ranging from about 10 nm to about 1 μm to form predetermined pores between particles.

When the mean particle diameter of the ceramic filler may be less than about 10 nm, the density of the ceramic filler is increased, and the sizes of pores are decreased to inhibit the migration of lithium ions, so that high rate charge/discharge or low temperature charge/discharge capacity is reduced. In addition, as the particle diameter of the ceramic filler is decreased, the surface area of the ceramic filler is increased, so that the amount of the binder in the ceramic filler having a mean particle diameter ranging from about 10 nm to about 1 μm is insufficient for the ceramic filler having a mean particle diameter less than about 10 nm. Thus flexibility of the ceramic layer 330 may be degraded. When the mean particle diameter of the ceramic filler may be greater than about 1 μm, the sizes of pores may be increased. In this case, an inner short circuit due to lithium dendrite growth easily occurs in a portion where the sizes of pores are large, so that the stability of a battery may be reduced.

The ceramic filler may include at least one selected from the group consisting of Al₂O₃, TiO₂, and BaTiO₃, but the present disclosure is not limited thereto.

The binder maintains the bonding between the first base material layer 310 and the ceramic layer 330, and the bonding between the second base material layer 320 and the ceramic layer 330, and strengthens the connection of the ceramic filler, so as to improve the strength of the ceramic layer 330.

The binder may include at least one selected from the group consisting of polyvinylidenefluoride (PVDF) and hexafluoropropane (HFP), but the present disclosure is not limited thereto.

The content of the ceramic filler may range from about 80 wt % to about 90 wt % based on the total weight of the ceramic layer, and the content of the binder may range from about 10 wt % to about 20 wt % based on the total weight of the ceramic layer, but the present disclosure is not limited thereto. When the content of the ceramic filler is less than about 80 wt %, the content of the binder is excessively large, so that the number of pores formed within the ceramic filler is decreased, and the sizes of the pores and porosity are reduced. Thus, the final battery performance may be degraded. When the content of the ceramic filler is greater than about 90 wt %, the content of the binder is excessively small, so that bonding force of the ceramic filler is reduced. Thus, mechanical properties of the ceramic layer 330 may be degraded.

As described above, when the ceramic layer 330 is disposed between the first and second base material layers 310 and 320, since the ceramic layer 330 is greater in heat resistance than the first and second base material layers 310 and 320, the first and second base material layers 310 and 320 can be prevented from being contracted at high temperature. In addition, even when the first and second base material layers 310 and 320 are damaged by melting down and contraction at high temperature, the ceramic layer 330 prevents a short circuit between the positive electrode plate 100 and the negative electrode plate 200.

A separator configured as described above may be manufactured using one of various methods, which will now be described in detail according to an embodiment.

FIG. 2 is a flowchart illustrating a process of manufacturing a separator applied to a lithium secondary battery according to an embodiment.

Referring to FIGS. 1 and 2, the separator is formed using a process including extrusion S10, interposing S20, and combining S30.

The extrusion S10 is an operation of extruding melted polyolefin based resin to form the first and second base material layers 310 and 320.

Each of the first and second base material layers 310 and 320 may be formed by extruding melted polyolefin based resin. Since the polyolefin based resin used to form the first and second base material layers 310 and 320, and its physical properties are described above, descriptions thereof will be omitted.

The interposing S20 is an operation of interposing the ceramic layer 330 between the extruded first and second base material layers 310 and 320.

The ceramic layer 330 may be interposed between the first and second base material layers 310 and 320 using one of various methods.

For example, the inner surface of at least one of the first and second base material layers 310 and 320 may be coated with a ceramic composition, or the ceramic layer 330 may be interposed between the first and second base material layers 310 and 320 through electrospinning The coating of the inner surface may be performed using a well known method such as knife coating and spray coating.

The interposing S20 and the extrusion S10 may be performed substantially at the same time. For example, the first and second base material layers 310 and 320 may be squeezed such that the first and second base material layers 310 and 320 are vertically spaced from each other, and then, the ceramic layer 330 may be interposed between the first and second base material layers 310 and 320 through coating or electrospinning.

The ceramic layer 330 may have a thickness ranging from about 2 μm to about 5 μm.

The combining S30 is an operation of combining the first base material layer 310, the ceramic layer 330, and the second base material layer 320 in the state where they are sequentially stacked. The combining can be any operation which can improve bonding forces between the first base material layer 310 and the ceramic layer 330 and between the second base material layer 320 and the ceramic layer 330. For example, the first base material layer 310, the ceramic layer 330, and the second base material layer 320 are inserted between two rollers while they are heated and pressed to improve bonding force between the first base material layer 310 and the ceramic layer 330 and bonding force between the second base material layer 320 and the ceramic layer 330.

After the completion of the combining S30 as described above, a combined structure of the first base material layer 310, the ceramic layer 330, and the second base material layer 320 may be used as a separator, or drawing S40 may be optionally performed on the combined structure. When tension force is applied to the combined structure along its longitudinal and lateral directions, the mechanical properties of the separator can be improved, thus improving the resistance of the separator against the melting and contraction at high temperature. Accordingly, the electrical stability of the lithium secondary battery may be improved.

Since the lithium secondary battery includes the separator having the interposed ceramic layer according to the embodiments, the melting and contraction of the separator caused by heat are inhibited, thus preventing a short circuit between the positive electrode plate and the negative electrode plate.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A separator for a lithium secondary battery comprising:
a first porous base material layer;
a second porous base material layer; and
a ceramic layer disposed between the first porous base material layer and the second porous base material layer.

2. A lithium secondary battery comprising a positive electrode plate, a negative electrode plate, and the separator of claim 1, wherein the separator disposed between the positive electrode plate and the negative electrode plate.

3. The lithium secondary battery as claimed in claim 2, wherein the first porous base material layer and the second porous base material layer have a permeability ranging from about 100 sec/100 ml to about 300 sec/100 ml.

4. The lithium secondary battery as claimed in claim 2, wherein at least one of the first and second porous base material layers has a porosity ranging from about 30% to about 70% of an entire volume

5. The lithium secondary battery as claimed in claim 2, wherein at least one of the first and second porous base material layers is formed of a polyolefin based resin.

6. The lithium secondary battery as claimed in claim 5, wherein the polyolefin based resin comprises at least one selected from the group consisting of polyethylene and polypropylene.

7. The lithium secondary battery as claimed in claim 1, wherein the first and second base material layers are formed of a polyolefin based resin, the first base material layer comprises at least one selected from the group consisting of polyethylene and polypropylene, and the second base material layer is formed of polyethylene.

8. The lithium secondary battery as claimed in claim 2, wherein the ceramic layer has a thickness ranging from about 2 μm to about 5 μm and comprises ceramic filler and a binder.

9. The lithium secondary battery as claimed in claim 8, wherein the ceramic filler comprises at least one selected from the group consisting of Al₂O₃, TiO₂, BaTiO₃, and combinations thereof, and the binder comprises at least one selected from the group consisting of polyvinylidenefluoride (PVDF), hexafluoropropane (HFP), and combinations thereof.

10. The lithium secondary battery as claimed in claim 8, wherein the ceramic filler has a mean particle diameter ranging from about 10 nm to about 1 μm.

11. The lithium secondary battery as claimed in claim 2, wherein the separator has a thickness ranging from about 15 μm to about 30 μm.

12. A separator for a lithium secondary battery, the separator comprising:
a first porous base material layer having a shutdown function when a temperature of the battery is over a predetermined temperature;
a second porous base material layer having a shutdown function when a temperature of the battery is over a predetermined temperature; and
a ceramic layer disposed between the first porous base material layer and the second porous base material layer, the ceramic layer,
wherein at least one of the first and second porous base material layers has a porosity ranging from about 30% to about 70% of an entire volume

13. A method of manufacturing a separator for a lithium secondary battery, the method comprising:
extruding a melted polyolefin based resin to form a first porous base material layer and a second porous base material layer;
interposing a ceramic layer between the extruded first and second porous base material layers; and
combining the first porous base material layer, the second porous base material layer, and the ceramic layer disposed between the first and second base material layers.

14. The method as claimed in claim 13, wherein the interposing of the ceramic layer comprises coating an inner surface of at least one of the first and second porous base material layers with a ceramic composition to form the ceramic layer.

15. The method as claimed in claim 13, wherein the interposing of the ceramic layer comprises forming a ceramic composition through electrospinning on an inner surface of at least one of the first and second base material layers to form the ceramic layer

16. The method as claimed in claim 13, wherein the extruded first and second porous base material layers have a permeability ranging from about 100 sec/100 ml to about 300 sec/100 ml

17. The method as claimed in claim 13, wherein at least one of the extruded first and second porous base material layers has a porosity ranging from about 30% to about 70% of an entire volume.

18. The method as claimed in claim 13, wherein the ceramic layer comprises ceramic filler and a binder.

19. The method as claimed in claim 13, wherein the ceramic layer has a thickness ranging from about 2 μm to about 5 μm.

20. A separator for a lithium secondary battery, the separator being manufactured using the method as claimed in claim 13.
